(19) United States
(12) Patent Application Publication
(10) Pub. No.: US 2014/0277791 A1
(43) Pub. Date: Sep. 18, 2014

(54) HYBRID GENERATOR

(71) Applicant: Planetary Power, Inc., Redmond, WA (US)

(72) Inventors: Roger X. Lenard, Edgewood, NM (US); Eric Melberg, Titusville, FL (US)

(73) Assignee: PLANETARY POWER, INC., Redmond, WA (US)

(21) Appl. No.: 14/217,749

(22) Filed: Mar. 18, 2014

Related U.S. Application Data
(60) Provisional application No. 61/801,468, filed on Mar. 15, 2013.

(51) Int. Cl. H02J 7/34; G05B 15/02

(52) U.S. Cl. CPC H02J 7/34; G05B 15/02
USPC 700/287; 290/50

(57) ABSTRACT

A hybrid generator may include a fuel powered engine; an alternator comprising a permanent magnet alternator head with at least 90% mechanical-to-electric efficiency, the alternator being coupled to the engine; one or more batteries to receive and store power routed from the alternator; a controller to maintain efficient operating speed of the engine at prime power; and a power converter or inverter to convert stored energy from the batteries into usable electricity for AC or DC loads.

### CROSS-REFERENCE TO RELATED APPLICATION

This application claims the priority of U.S. Provisional Application No. 61/801,468, filed on Mar. 15, 2013, which is incorporated herein by reference in its entirety.

### FIELD OF INVENTION

The present invention relates to efficient energy production, storage, and manipulation.

### BACKGROUND OF THE INVENTION

There is a need for improved power for remote sites or where fuel is expensive, locations where a variety of user power needs are required, and also for locations where periods of quiet operations are necessary for operational needs, e.g., hospitals, military sentries, outdoor events, etc.

There exist a number of disadvantages to prior approaches. For example, it is essential to tackle generator system inefficiencies from the time the fuel enters the engine until the power is consumed by the user. Prior approaches have failed to recognize opportunities to improve system efficiency.

### SUMMARY

Aspects of the invention may involve one or more machines and one or more methods. In one embodiment of the invention, a hybrid generator may exist. The hybrid generator may include a fuel powered engine; an alternator comprising a permanent magnet alternator head with at least 90% mechanical-to-electric efficiency, the alternator being coupled to the engine; one or more batteries to receive and store power routed from the alternator; a controller to maintain efficient operating speed of the engine at prime power; and a power converter or inverter to convert stored energy from the batteries into usable electricity for AC or DC loads.

In another embodiment of the invention, a method may exist for operating a hybrid generator. The method may include, initiating startup by a system controller; measuring battery power level by the system controller; energizing one or more glow plugs; energizing an engine starter for an engine, the engine coupled to an alternator; starting the engine; cooling the engine using a water jacket; determining, by the system controller, if the engine started; measuring, by the system controller, a temperature of a liquid in the water jacket; instructing, by the system controller, the generator to produce energy at a selected percentage of the alternator maximum capacity based on the measured water jacket temperature; instructing, by the system controller, the engine to operate at the most efficient power setting regardless of a requested energy demand; storing excess output in batteries; and initiating a shutdown of the engine when the measured battery power level reaches a designated level.

### BRIEF DESCRIPTION OF THE DRAWINGS

The foregoing and other features and advantages of the invention will be apparent from the following, more particular description of various embodiments, as illustrated in the accompanying drawings wherein like reference numbers generally indicate identical, functionally similar, and/or structurally similar elements. The first digits in the reference number indicate the drawing in which an element first appears. Unless otherwise indicated, the accompanying drawing figures are not to scale.

FIG. 1 depicts a perspective view of an example portable hybrid generator in an embodiment of the present invention;

FIG. 2 depicts a side view of the example portable hybrid generator;

FIG. 3 depicts a bottom view of the example portable hybrid generator;

FIG. 4 depicts a top view of the example portable hybrid generator;

FIG. 5 depicts a perspective view of the example portable hybrid generator with panels removed;

FIG. 6 depicts an example schematic diagram of an example portable hybrid generator in an embodiment of the present invention;

FIG. 7 depicts an example exhaust gas heat exchanger;

FIG. 8 depicts an example diffuser;

FIG. 9 depicts an example exhaust gas heat extraction assembly;

FIG. 10 depicts an example water jacket heat exchanger;

FIG. 11 depicts an example flowchart describing processing performed in an illustrative embodiment;

FIG. 12 depicts an example computer processing system that may be used in implementing an illustrative embodiment of the present invention;

FIG. 13 depicts an example initial control panel screen in an illustrative embodiment;

FIG. 14 depicts an example power control sub system control panel screen in an illustrative embodiment;

FIG. 15 depicts an example engine data control panel screen in an illustrative embodiment; and

FIG. 16 depicts an example alarm control panel screen in an illustrative embodiment.

### DETAILED DESCRIPTION

Illustrative embodiments are discussed in detail below. While specific embodiments are discussed, it should be understood that this is done for illustration purposes only. In describing and illustrating the embodiments, specific terminology is employed for the sake of clarity. However, the embodiments are not intended to be limited to the specific terminology so selected. A person skilled in the relevant art will recognize that other components and configurations may be used without departing from the spirit and scope of the embodiments. It is to be understood that each specific element includes all technical equivalents that operate in a similar manner to accomplish a similar purpose. The examples and embodiments described herein are non-limiting examples.

Furthermore, the embodiments detailed below may be combined into a new embodiment and/or various features of the embodiments described below may be combined to form a new embodiment.

All publications cited herein are hereby incorporated by reference in their entirety. As used herein, the term “a” refers to one or more. The terms “including,” “for example,” “such as,” “e.g.,” “may be” and the like, are meant to include, but not be limited to, the listed examples.

According to one embodiment, generator power output may be converted to direct current and charge batteries. The embodiment may ensure that the generator only operates at peak efficiency (e.g., full power rating). The generator may be shut off when the batteries are fully charged. The generator may be restarted when the batteries are depleted or reach a specified level of depletion. The known prior approaches fail to replace highly inefficient generator heads with, for example, high efficiency permanent magnet generator heads. For example, in one experiment, the generator head had an advertised efficiency of 79%, however, measurements indicated the actual operating efficiency was closer to 70%. This means that 30% of the chemical energy available as rotational mechanical energy was turned into heat due to generator head inefficiencies. On the military's Tactical Quiet Generators, for example, the generator head selected, because power form management was partially done at the generator head, was particularly inefficient, with as much as 40% of the chemical energy being wasted as heat in the generator windings.

In one embodiment, the inefficient generator head of a standard generator was replaced with a new head of approximately 93% mechanical-to-electric efficiency. In tests, this improvement was observed. Additionally, very high efficiency AC-DC conversion may be employed, along with highly efficient batteries which may possess high pass-to-pass efficiency. In addition, a highly efficient inverter (e.g., >96%) may be used with features allowing it to exhibit selectable power forms. Further embodiments are described in detail below.

A hybrid generator (e.g., HYGEN™), such as described herein, fills a longstanding need in the portable generator set arena by addressing current problems such as generators operating very inefficiently and consuming copious quantities of fuel running at partial load. In one embodiment of the invention, the generator may be forced to operate at its most efficient power setting (e.g., prime power), regardless of the user demand. An embodiment may be able to operate a generator at it most efficient power setting because of an on-board battery storage which may allow excess energy to be stored if the user demand is less than a generator's optimum operating regime. If, for example, the user demand is well-matched to the power output, then very little power may be sent to the batteries. Alternatively, if the load is poorly matched to the generator's output, (as is usually the case), then a significant fraction of the generator's output may be stored in the batteries. Once the batteries are charged, the engine may be shut off and the batteries may operate the user load for many hours without the generator operating saving substantial fuel, reducing noise, and reducing emissions.

One embodiment may be comprised of a fuel powered engine (e.g., diesel, gasoline, hydrogen, natural gas etc.) and associated control and sensor wiring, an alternator with interface plate and torsional coupling, engine and generator mounts that mount it to a trailer frame, power leads from the generator to the first stage power conditioner, an AC-DC power converter consisting of three AC wires in and two DC wires out, plus control wiring from a system controller to the AC-DC converter, DC power wires leading to the batteries and to the second stage power converter (inverter), high power batteries, and batteries to operate the engine and system controller and electric fan, a main power disconnect switch, several circuit protection devices, and a Human-Machine Interface (HMI) panel. The HMI allowing a user to configure and view settings for the system controller.

FIG. 1 depicts a perspective view of an example portable hybrid generator 100 in an embodiment of the present invention. Portable hybrid generator 100 includes a hybrid generator coupled to a portable trailer frame. In some embodiments, portable hybrid generator 100 may not be coupled to a trailer and/or may be located permanently at a location.

FIG. 2 depicts a side view of the example portable hybrid generator 100. As shown in FIG. 2, example portable hybrid generator 100 includes trailer frame 200, tire and axle assembly 204, spare tire 206, forward trailer jack 210, rear trailer jack 212, adjustable channel mount for coupler 214, safety chains 216, red reflector 220, amber reflector 222, side light 224, engine vent louvers 230, vent 232, exhaust pipe and exhaust cap 234, fuel filler neck and cap 236, receptacle panel access door 240, electronics and breaker panel access door 242, programmable logic computer (PLC) panel access door 244, battery disconnect switch 250, antenna 260, and PV power input port 270.

Trailer frame 200 may be leveled using forward trailer jack 210, rear trailer jack 212. Rear trailer jack 212 may include one or more jacks. Trailer frame 200 may be connected to a truck or other transportation using adjustable channel mount for coupler 214 and one or more safety chains 216 may also be connected.

Rear reflector 220, front reflector 222, and/or side light 224 may include one or more reflectors or reflecting material, and/or a light producing device (e.g., LED). Rear reflector 220 may be red, front reflector 222 may be amber colored, and side light 224 may emit white light.

Engine vent louvers 230 and/or vent 232 may be used to provide cooling for portable hybrid generator 100. Exhaust pipe and exhaust cap 234 may be used to expel waste gas and prevent rain from entering exhaust pipe. Fuel filler neck and cap 236 may provide assess for fuel (e.g., diesel, gasoline, biodiesel, etc.) to be inserted into a fuel storage unit (e.g., tank).

Receptacle panel access door 240 may provide access to access to one or more power receptacles (e.g., one or more 120V single phase, 208V three phase, 220V single phase, 380V three phase, 230V single phase, 400V three phase, 240V single phase, and/or 415V three phase). Electronics and breaker panel and access door 242 and PLC panel access door 244 may provide a user with access to control circuitry, system controller, and/or a software interface (e.g., an HMI panel). Main disconnect switch 250 allows a user to disconnect all the batteries from the supplied receptacles, engine and control system. This is the main safety disconnect—the system will not start or operate when main disconnect switch 250 is open—main disconnect switch 250 also acts an emergency shut-down device. The access doors 240, 242, 244 and main disconnect switch 250 may include weather-tight seals.

PV power input port 270 may provide access for external power to be input into the generator 100. For example, external power from solar panels, wind turbines, conventional power grid, other generators, etc., may be used to supply output power and/or charge batteries of generator 100.

Antenna 260 may provide wireless remote access to portable hybrid generator 100. Remote access may include the same functionality and control that is provided by the HMI connection. Remote access may also provide monitoring on performance, fuel consumption, and/or upcoming maintenance.

In an embodiment, the operation of portable hybrid generator 100 may be straightforward and simple, with minimal operational user interactions. An operator, after checking engine fluids, turns on the main battery disconnect switch 250. After the battery disconnect switch 250 is turned on, a system controller and a HMI panel may be energized. The HMI panel is found, for example, inside the electronics and circuit breaker panel door 242. The HMI panel may employ a touch-screen protocol for inputting commands. As an additional feature, the operator may connect to the system wirelessly (e.g., Wi-Fi) via a device (e.g., laptop computer, tablet, mobile device, etc.) through antenna 260. Portable hybrid generator 100 through antenna 206 may provide signals and reception sufficiently strong such that a connection may be maintained at a distance of over 500 feet from portable hybrid generator 100. The control system may undergo a series of pre-startup checks and may ask an operator if they wish to operate in a manual mode, or an automatic mode. The manual mode may allow the operator to ascertain main battery state of charge and operator load and determine when the unit should be turned-on or shut-off. Automatic mode may allow portable hybrid generator 100 to calculate and determine the main battery state of charge and operator load to determine when the unit should be turned-on or shut-off for optimal fuel efficiency and/or battery life. The operator may connect load sources to a power receptacle access array, located behind receptacle panel access door 240, to power desired equipment. The operator receptacle plane may contain, for example, six 120 Volt GFI protected circuits and one 208 V three-phase 60 amp circuit for the ability to start larger 3 phase loads (up to 30 kW for 10-20 minutes and up to 2 seconds for a 60 kW load, for example). Once the battery pack is depleted to a pre-determined state of charge, the unit may start itself up automatically to meet operator load and to charge the batteries.

In an embodiment, a starting sequence may be as follows. Once portable hybrid generator 100 decides that the batteries need to be charged or if the operator manually commands portable hybrid generator 100 to engine start, portable hybrid generator 100 may emit an audible warning tone that beeps slowly and then with increasing frequency for up to a designated time (e.g., six seconds) prior to start. Next, a glow-plug relay may energize glow plugs for another designated time (e.g., approximately 10 seconds). Then, the battery contactor may energize an engine starter. The engine starter may then start the engine. A logic sequence in a programmable logic computer of the system controller may assess whether or not the engine has started. If the engine has not started within the allotted crank time, a wait state may be entered to allow the starter to cool, and the process elaborated above is attempted up to a designated number of times (e.g., two). If the engine has not started by, for example, the third attempt, the system controller may enter a fault state that may be displayed as a warning on the HMI panel. Notice that portable hybrid generator 100 did not start may be provided to the operator.

If the engine successfully starts, the system controller may ascertain whether or not the engine has achieved proper operating speed. If the engine has achieved proper operating speed (the operating speed is dependent on the engine, e.g., approximately 1800 rpm), the operational sequence may continue. If the engine has not achieved proper operating speed after a pre-determined period of time, the engine may shut down and a fault may be sent to the HMI which may describe the current state and/or problem.

If the engine has achieved proper operating speed, the system controller may measure the engine water jacket temperature. When the engine water jacket temperature reaches an initial designated temperature value (e.g., 85 degrees F.), the system controller may command the generator to put out The engine may be a constant speed engine running at 1800 rpm, for example) for example, an initial designated percentage (e.g., approximately 15%) of alternator prime power capacity. The PLC may command the GTI to produce a current to the DC bus (the current times the rms voltage is the output power). When the temperature reaches a second designated temperature value (e.g., 140 F), the system controller may command a second designated percentage (e.g., 50%) of alternator prime power capacity, and when, for example, a normal operating temperature is reached (e.g., approximately ˜160-180 F) (an alarm temperature may be less than 105 F and the fault temperature may be less than 112 F), 100% prime load may be commanded. The designated temperatures and designated percentage of alternator prime capacity may have initial default values based on the type of engine and/or may be configurable through the HMI connection and/or through the wireless connection. Environmental factors (e.g., temperature, altitude, humidity, atmospheric pressure, etc.) may require a change in the default values which may be calculated automatically or entered in manually.

The engine may continue to operate until the batteries reach a pre-determined full state of charge or if the operator commands a shutdown. When a shutdown is initiated, the system controller instructs the load to be gradually reduced until a zero-load state is achieved, at which point the engine is shut down. The engine may remain in a wait state until battery energy reaches a low point (at which the system controller begins the engine start sequence), the operator manually starts it, or the hybrid generator is shut down and the main battery disconnect switch 250 is shut off.

Other than in times of initial power-up or shut down, the engine operates at its most efficient level (e.g., at full prime power).

FIG. 3 depicts a bottom view of the example portable hybrid generator 100. In one embodiment, the trailer frame 200 may be made from 2″×2″ box tube steel in a rectangular pattern and welded at the intersections. The tongue framework may be a weldment that is welded to the main framework. Coupled to trailer frame 200 may include engine floor plate 310, fuel tank support plate 320, battery case support plate 330, and axle housing 340.

FIG. 4 depicts a top view of the example portable hybrid generator 100. In one embodiment, inner main frame elements may exist that are also made from 2″×2″ box tube, including the fuel tank frame and the longerons internal to the main framework 200. The engine compartment of portable hybrid generator 100 may include removable lower panels for servicing the engine such as engine floor plate 310. The panels and plates of portable hybrid generator 100 may be covered with sound-proofing to minimize noise. The battery case support plate 330 may support a battery box at the front end of the trailer. The axle housing 340 may be welded to the frame 200 once the center of mass is determined. The axle may be a commercial 6,000 pound torsional axle with commercial rims and tires. The trailer lighting receptacles may be welded ⅛″ steel in order to protect the trailer lighting. FIG. 4 depicts the collar lock coupler 410, brake controller 420, engine compartment roof door 430, and fenders 440. Fenders 440 may be detachable in order to access inner portions of the generator set.

FIG. 5 depicts a perspective view of the example portable hybrid generator 100 with panels removed. In one embodiment, the generator is powered by a fuel consuming engine 500, for example, a Perkins 403D-11G Electropak diesel engine. Connected to engine 500 is a specialty-wound permanent magnet alternator 505. Engine 500 may include a water jacket used for cooling the motor. Exhaust from engine 500 may be routed through muffler 540 before being routed to a waste heat exchanger. If engine 500 operates at 12, volts, engine alternator 505 may be changed to a 24V alternator to charge, for example, two 12 V batteries wired in series to provide 24 volts to system controller 510. The engine mechanically operated fan was removed and replaced with a 24V electrically driven fan 515. Fan 515 may have fan shroud 520. Three-phase AC electrical power from alternator 505 may be routed to the OCC rectifier 525, where the three-phase AC may be converted to DC. The DC power may be routed to main battery packs 535 and to load inverter 530. Output from inverter 530 may be routed through a fuse pack located in the electronics bay 545. The power may then routed to the one or more power receptacles such as 120 VAC circuits and GFI protected (e.g., 6-pack) outlet panel 550 and to the one or more 208 VAC three phase receptacles 555. External power may be inputted through high voltage DC contactor 560, through a fused link and into the main DC buss 565. The contactor 560 may be controlled by the PLC and/or system controller 510 and may be engaged, for example, whenever the main battery bus voltage drops below a given threshold. When DC contactor 560 is engaged, the external power source may power the power DC bus (with or without engine running) until main DC buss 565 reaches a specified value, at which time the contactor may be disconnected. The external power source (e.g., wind, solar, other generator, main power grid, etc.) may be used to charge batteries 535 and/or to help provide electricity for the demand placed on generator 100. Optional turbocharger 570 may also be installed.

Internal mounting frames are depicted as shown throughout and may be comprised primarily of ⅛″ angle iron custom fitted and drilled material. Engine compartment exterior siding may be covered with sound-proofing insulation to reduce noise and thermal signature. Jacks 212, 210 may be provided to level portable hybrid generator 100 and to mount and dismount from a tow vehicle. Waste heat extraction from engine exhust and engine water jacket may also be performed.

Use of a permanent magnet alternator 505 (e.g., four-pole permanent magnet rotor) instead of a standard generator head dramatically improves efficiency independent of using battery energy storage to improve operating efficiency. Such an alternator may have at least 90% mechanical-to-electrical efficiency. Using electrical fan 515 instead of a mechanical fan uses less than half the power and is more silent. Sound deadening also reduces the unit's thermal signature. Using an inverter that can surge to 300%-400% of generator rated load in order to start large inductive loads provides non-obvious advantages. For example, the generator need only be sized for the average load, not the peak load, thereby saving consider expense in initial purchase cost, and considerable expense in reduced operating costs. Additionally, the inverter need be only sized to meet the average, not peak load saving considerable capital investment costs.

The description of the invention has been presented for purposes of illustration and is not intended to limit the invention to the form or forms disclosed herein. For example, the invention may incorporate aspects of hybrid diesel generators described and shown in commonly owned U.S. patent application Ser. No. 13/210,163, Lenard, for “COMBINED ENERGY GENERATION AND STORAGE”, filed Aug. 15, 2011, which is incorporated herein by reference in its entirety. Further embodiments are as follows.

Another embodiment may incorporate the above features in the aforementioned description but replace alternator 505 with an encoder-based permanent magnet servo motor (such as, MAC-GVM-210100-K1N). Furthermore, the first stage of power conditioning, (e.g., converting three phase AC to DC) may be achieved by using a modified commercially available servo motor drive (such as Ormec 400V SAC-XD450-SDOOR0-J001) which operates the servo motor in torque mode. This reduces the cost of the first stage power conditioning and makes the unit more affordable. Additionally, the typical single power form inverter may be replaced with an inverter (such as OCC 4 W liquid-cooled inverter) capable of meeting 120V single phase and 208V three phase, 60 Hz and 220V single phase and 380V three phase, 50 Hz, and 230V single phase and 400V three phase, 50 Hz, and 240V single phase and 415V three phase 50 Hz, and (120V/240V single phase and 208V three phase plus 277V single phase and 480V three phase 60 Hz simultaneously)—all from the same DC bus structure.

Another embodiment may incorporate the above features along with a frequency/voltage reference that can be daisy-chained between the output inverters so individual units can be bridged together to form a mini generating grid which can switch generators in and out to meet loads from, for example, 2 kW to 2 MW, all by integrating a single generator system. Additionally, the DC busses may be connected together to enable large amounts of energy storage. Generators may be switched on and off to optimally meet operator demand and to charge batteries at a very low (e.g., life enhancing) state of charging. The grid of multiple portable hybrid generators 100 connected together may be controlled by a single HMI or a remotely via antenna 260.

Another embodiment may include a small turbocharger 570 to improve the operation of the system at higher elevations and improve the efficiency of the portable hybrid generator 100. An example turbocharger 570 may include, for example, the Honeywell Garrett GT06.

Another embodiment may include a turbocharger and an electronic throttle control. This allows engine 500 to be throttled to lower power to meet reduced needs of the battery charging unit to enhance system lifetime. This can be done to maintain the most modest quantity of battery storage feasible to reduce total costs. The electronic throttle control also allows the unit to increase its speed to produce more power, potentially up to, for example, 30 kW continuous in the turbocharged version.

Another embodiment may include receiving and incorporating power from solar panels or other power source. For example, the PV panels may be specially connected to match the DC buss voltage at the maximum battery storage point. The PV electrical energy may be routed to the PV power input port 270, through for example high voltage DC contactor 560, through a fused link and into the main DC buss 565. DC contactor 560 may be controlled by the PLC and/or system controller 510 and may be engaged whenever the main battery bus voltage drops below, for example, 340 VDC. Diodes in the PV arrays may prevent reverse current flow when, for example, the sun is not shining. When contactor 560 is engaged, the PV power the DC bus (with or without engine running) until the main DC buss 565reaches, for example, 400 VDC, at which time the contactor may be disconnected.

Another embodiment may include a waste heat extraction with a small waste heat recovery expander (e.g., Waste Heat Recapture Subsystem (WHRS)) to further increase efficiency. Another embodiment may include water recovery from collected condensation of the exhaust during heat extraction to produce potable (after filtering) of water. This may be particularly useful in desert areas or in areas where water is difficult to acquire. This embodiment works because the combustion of fuel produces large quantities of water which dramatically increases the dew-point of the air entering the engine, as such, the water will condense from the exhaust as it is cooled to normal air temperatures.

FIG. 6 depicts an example schematic diagram of an example portable hybrid generator 100 in an embodiment of the present invention that includes a waste heat recapture system (WHRS). As shown in FIG. 6, the primary power generation is performed in section 610 with engine 500 and alternator 505. Power conditioning, storage, and control shown in section 630 include, for example, rectifier 525, inverter 530, and batteries 535. Waste heat recapture (WHRS) is shown as 620 and is described below.

WHRS 620 captures heat from the engine 500 (e.g., a diesel engine) exhaust and water jacket that is used for cooling the motor. The heat captured by the Exhaust Gas Heat Exchanger (EGHX) and/or the Water Jacket Heat Exchanger (WJHX) may be transferred to a working fluid (e.g., R-600a isobutane refrigerant) that may power a positive displacement trochoidal topology expander motor (e.g., a “R600A Motor”). In an alternative embodiment, a turbine expander may be involved. This Organic Rankine Cycle (ORC) may drive a second generator head, which may add, for example, approximately 20% output power to the baseline generator set. The working fluid (e.g., R-600a refrigerant) may then be passed through one or more condensers to return it into liquid state prior to being returned to the heat exchangers.

FIG. 7 depicts an example exhaust gas heat exchanger (EGHX) 700. The EGHX 700 may be used to transfer the heat from the exhaust gasses to the working fluid. In one embodiment, the EGHX 700 dimensions are 13.1 inches in length by 8 inches in width by 6 inches in height. EGHX 700 may feature 15 heat exchanger rows in which the working fluid (e.g., R-600a refrigerant) may be first heated as a liquid then boiled and the vapor superheated. The exhaust stream exits engine 500 (e.g., a diesel motor) through, for example, a 2 inch diameter circular manifold. However, EGHX 700 may have a larger face area (e.g., 6 inches by 8 inches). Therefore, a diffuser may be required to evenly distribute the exhaust gases for optimal heat extraction.

FIG. 8 depicts an example diffuser 800 that may be used by EGHX 700 to evenly distribute exhaust gases for optimal heat extraction. Similarly, a convergent nozzle was required on the EGHX exit side to maintain sufficient backpressure to maximize heat extraction. To maintain attached flow during the diffusion, in one embodiment, a maximum angle of 13 degrees was selected, which resulted in the inlet diffuser being 16.125″ inches long and the outlet diffuser being 10.125″ long (measured flange-end to flange-end).

FIG. 9 depicts an example exhaust gas heat extraction assembly 900 including EGHX 700, an inlet diffuser 800, and an outlet diffuser 800. The entire exhaust gas heat extraction assembly 900, including the exhaust manifold, was wrapped in two inch thick Silcosoft insulation 910 and mounted between engine 500 (e.g., a diesel motor) and a EXHX mounting bracket.

FIG. 10 depicts an example water jacket heat exchanger (WJHX) 1000. To extract heat from the water jacket, a baseline generator set cooling system was modified by removing the radiator and fan and plumbing coolant through the WJHX 1000 and then back into the engine. The reduced temperature and the nature of the liquid-liquid heat transfer allowed an “off-the-shelf” plate-fin heat exchanger to be used. To maximize water jacket heat capture the WJHX 1000 was insulated with sound deadening thermal insulation (e.g., one inch Silcosoft insulation). The WJHX 1000 was mounted inverted and two purge valves were installed to enable system flush and purging. Connecting hoses are, for example, high temperature, high pressure silicon racing hoses with special stainless steel “T”-clamps.

FIG. 11 depicts an example flowchart describing processing performed in an illustrative embodiment. Flow may start at 1110 where startup of the hybrid generator is initiated. For example, the battery disconnect switch 250 may be turned on by an operator and system controller 510 and the HMI panel may be energized. Further commands may be inputted into the HMI to start the fuel powered engine or to read system settings such as the current system status, battery power level, fuel level, etc. Commands and/or system settings may be entered and or accessed via the HMI, remotely via antenna 260, or both. When startup is initiated, system controller 510 may undergo a series of pre-startup checks and may ask an operator if they wish to operate in a manual mode or in an automatic mode. If system controller 510 detects inconsistencies or errors, an error message may be displayed on the HMI or on a remote display. On initialization, system controller 510 may read default system values and parameters from stored memory (e.g., a stored configuration file) and/or from user input from the HMI panel or remote access via antenna 260. From 1110, flow may move to 1120.

In 1120, the system controller 510 may measure the current battery 535 power level. System controller 510 may also measure the current demand. Along with the current demand, batteries 535 may also be continuously or periodically measured to determine a current power level. System controller 510 may determine that fuel based engine 500 needs to be started to meet current power demand and/or to charge batteries 535. From 1120, flow may move to 1130.

In 1130, the system controller 510 may start fuel based engine 500. To warn or indicate any people near hybrid generator 100 that the engine will soon start, hybrid generator 100 may emit an audible warning tone that beeps slowly and then with increasing frequency for up to a designated time prior to engine 500 start. A glow-plug relay may energize glow plugs for another designated period of time. The battery contactor may then energize an engine starter. The engine starter may then start engine 500. From 1130, flow may move to 1140.

In 1140, system controller 510 may measure parameters of engine 500 and/or determine the current status of engine 500. For example, system controller 510 may determine if engine 500 has started. If engine 500 has not started after a period of time, a wait state may be entered to allow the starter to cool, and the engine startup process may be attempted a designated number of times (e.g., two). If engine 500 has not started by the designated number of times, system controller 510 may enter a fault state that may be displayed as a warning on the HMI panel providing notice that portable hybrid generator 100 did not start. If engine 500 did not start, system controller 510 may initiate engine 500 shut down at 1190.

If the engine has started, system controller 510 may ascertain whether or not engine 500 has achieved a proper operating speed. If engine 500 has not achieved proper operating speed after a pre-determined period of time, system controller 510 may initiate engine 500 shut down at 1190 and a warning may be sent to the HMI describing the current system state and/or the engine problem. If engine 500 has started and achieved proper operating speed, the operational sequence may continue. From 1140 flow may move to 1150.

In 1150, system controller 510 may continuously or periodically measure the engine water jacket 1000 temperature (e.g., the temperature of the liquid in the engine water jacket 1000). The liquid in the engine water jacket 1000 may or may not be water. From 1150, flow may move to 1160 and flow may move back and forth between 1160 and 1150 as the temperature of engine water jacket 1000 increases.

In 1160, system controller 510 may request a level of power output from the fuel based generator 500 and/or alternator 505. When the engine water jacket 1000 temperature reaches an initial designated temperature value (e.g., 85 F), system controller 510 may request generator 500 and/or alternator 505 to supply, for example, an initial designated percentage (e.g., 15%) of alternator prime power capacity. When the temperature reaches a second designated temperature value (e.g., 140 F), system controller 510 may request a second designated percentage (e.g., 50%) of power capacity. When, for example, a normal operating temperature is reached, system controller 510 may request an optimal percentage (e.g., 100% prime load) of power capacity. The designated temperatures and designated percentage of requested power capacity may have initial default values based on the type of engine and/or may be configurable through the HMI connection and/or through the wireless connection. System controller 510 may also detect the optimum configuration values based on the engine type, fuel, and/or environmental factors. If the system controller 510 detects that the engine water jacket 1000 temperature exceeds a maximum temperature, system controller 510 may enter a fault state that may be displayed as a warning on the HMI panel providing notice that generator 100 and/or engine water jacket 1000 exceeds designated temperature values and system controller 510 may initiate engine 500 shutdown at 1190. From 1160, flow may move to 1170.

In 1170, system controller 510 may request generator 500 and/or alternator 505 to operate at the most efficient power capacity regardless of the power demand. Often for diesel engines, this is 100% capacity. From 1170, flow may move to 1180.

In 1180, heat from the engine water jacket 1000 and/or from the exhaust gas of generator 500 may be extracted. The captured heat may be transferred to, for example, a working fluid that may power an expander motor. Based on an Organic Rankine Cycle (ORC), a second generator head may be driven providing additional power to meet demand and/or to be stored in batteries 535. Solar panels located, for example, on the top of hybrid generator 100 may also supply additional energy to meet power demand and/or to be stored in batteries 535. From 1180, flow may move to 1185.

In 1185, excess power may be stored in batteries 535. System controller 510 may measure power created by, for example, primary power (e.g., fuel based generator 500 and/or alternator 505), waste heat recapture system 620, and/or solar panels. Any excess created power after the demand has been met, may be stored in batteries 535. From 1185, flow may move to 1190.

In 1190, engine 500 and/or hybrid generator 100 may be shut down. When an operator commands system controller 510 to shut down (e.g., through HMI or remotely via antenna 260) or system controller 510 detects that batteries 535 reach or exceed a defined charge state, system controller 510 may initiate engine 500 shut down. When a shutdown is initiated, system controller 510 may instruct the load on generator 500 and/or alternator 505 to be gradually reduced until a zero-load state is achieved, at which point engine 500 is shut down. Engine 500 may remain in a wait state until battery energy reaches a low point (at which system controller 510 may begin the engine start sequence (e.g., 1120)), the operator manually starts engine 500, or the hybrid generator 100 is shut down and the main battery disconnect switch 250 is shut off. From 1190, flow may end.

One embodiment of generator 100 may include a heavy-duty Perkins 4 cycle diesel engine certified by the Environmental Protection Agency (EPA) to conform to Tier 4 final non-road emissions regulations, a high density permanent magnet alternator 505 regulated by an industrial control system that allows for easy user interface. A heavy-duty constructed chassis supports the complete set. The generator may be protected by a best-in-class sound attenuated enclosure designed for durability and extreme application. Batteries 510 may be Lithium Ion batteries capable of over 7000 charging cycles, with a DC bus charge of 750 volts, a total capacity of 28.6 kWh, and usable storage of 14.3 kWh. Generator 100 may also include inverter 530 capable of many field selectable power forms and direct DC Bus connection for accepting PV or Wind power input. Engine 500 may be a 60 Hz diesel engine running at 1,400-2,700 rpm, with a peak at 60 kW and 68 kVA and a prime at 20 kW and 22 kVA, with a sound rating at 7 m of 65 dBA. Engine 500 may include an industrial grade Tier IV Perkins diesel Engine, stroke, water cooled, provided with: 12V electric start, radiator with pusher fan, water separator visible level fuel filter, secondary water separator fuel filter, mechanical engine governor, HWT/LOP senders, heavy duty 2-stage air filter with service indicator, hot & rotating components (exhaust, fan, etc.), protections and radiator guards, and spin type fuel and oil filters. Engine 500 may have maximum power at 2,100 RPMs with an output of 20 kW.

Alternator 505 may include, at least, brushless construction, high performance, high density magnets, and thermistor protection. Alternator 505 may have a maximum output of 20 kW, conversion efficiency of 92%, liquid cooling, and an output frequency (unregulated AC) ˜90 Hz.

In an example embodiment, control system 510 may include the following features. A digital microprocessor based control panel with remote start capability. Control system 510 may provide at least the following readings and alerts for engine protection and maintenance: coolant temperature, high coolant temperature, high coolant temperature by sensor, low engine temperature by sensor, oil pressure, low oil pressure, coolant level, low coolant level, unexpected shutdown, fuel level (e.g., percentage of fuel), low fuel level, stop failure, battery voltage, battery voltage failure, battery charge alternator voltage, battery charging alternator failure, speed (e.g., RPMs), over-speed, under-speed, start failure, and emergency stop. Alternator readings and alerts for alternator protection may include, at least: frequency, over frequency, under frequency, voltage, over voltage, under voltage, short-circuit, unbalanced voltage, incorrect phase sequence, reverse power, and overload. Genset readings may include: voltage among phases, voltage among phases and neutral, amperage, frequency, apparent power (kVA), active power (kW), reactive power (kVAr), and power factor. Digital Metering may include: total hour counter, partial hour counter, kW meter, valid starts counter and failed starts counter, and maintenance. Control system 510 may be remote communications capable and other optional communications may include: RS232, RS485, modbus, analog modem, GSM/GPRS modem, and/or remote screen. Other features of control system 510 may include: alarms history, external start, start inhibition, start under EJP normative, pre-heating engine control, genset contactor activation, engine temperature control, manual override, programmable alarms, genset start function in test mode, and programmable outputs. Control system 510 may also include an on/off switch, an emergency stop button, and data logging.

In an example embodiment, generator 100 may include power panel 550 which may include 3P main line circuit breaker for overload, Mennekes AMAXX® power distribution panel, auxiliary socket box IP67, with individual breaker protection, 2 GFCI DUPLEX 20A 125VGF1 for 110v duplex and TWIST-LOCK 50A 2P+N+G, and direct access to auxiliary sockets with suitable protection.

The chassis for generator 100 may include an extended run time high capacity fuel tank, 135% spill containment for all fluids, easy access for chassis cleaning and component access, vibration isolators between chassis and generator, and a heavy duty skid base with forklift pockets.

Generator 100 may also include a heavy duty sound attenuated enclosure with powder coat paint which exceeds 1,000 hour salt spray test, stainless steel hardware and fasteners, reinforced lifting points, fuel tank external filling system (lockable filler cap), emergency stops (double protection for emergency stop; inside on control panel and external on enclosure), door with window to view control panel, easy access to radiator fill, NEMA enclosure for power cables. The exhaust system may include a steel residential silencer of −35 dBA attenuation.

Inverter 530 may include One-Cycle Control technology, a power factor >0.99, current harmonics <3%, effciency >97%, stable zero load operation, and leading response speed within 100 s of microseconds. Inverter 530 may have a rated output of 33 kW, a 3 phase Max surge load of 60 kW, liquid cooling, an output frequency (regulated AC) of 60 Hz, single phase of 120/208/240/277 volts and three phase of 208/220/440/480 volts.

FIG. 12 depicts an example computer system that may be used in implementing an illustrative embodiment of the present invention. Specifically, FIG. 12 depicts an illustrative embodiment of a computer system 1200 that may be used in computing devices such as, e.g., but not limited to, standalone, client, server devices, or system controllers. FIG. 12 depicts an illustrative embodiment of a computer system that may be used as client device, a server device, a controller, etc. The present invention (or any part(s) or function(s) thereof) may be implemented using hardware, software, firmware, or a combination thereof and may be implemented in one or more computer systems or other processing systems. In fact, in one illustrative embodiment, the invention may be directed toward one or more computer systems capable of carrying out the functionality described herein. An example of a computer system 1200 is shown in FIG. 12, depicting an illustrative embodiment of a block diagram of an illustrative computer system useful for implementing the present invention. Specifically, FIG. 12 illustrates an example computer 1200, which in an illustrative embodiment may be, e.g., (but not limited to) a Ormec SMLC system and/or a personal computer (PC) system running an operating system such as, e.g., (but not limited to) MICROSOFT® WINDOWS® NT/98/2000/XP/Vista/Windows 7/Windows 8, etc. available from MICROSOFT® Corporation of Redmond, Wash., U.S.A. or an Apple computer executing MAC® OS or iOS from Apple® of Cupertine, Calif., U.S.A. However, the invention is not limited to these platforms. Instead, the invention may be implemented on any appropriate computer system running any appropriate operating system. In one illustrative embodiment, the present invention may be implemented on a computer system operating as discussed herein. An illustrative computer system, computer 1200 is shown in FIG. 12. Other components of the invention, such as, e.g., (but not limited to) a computing device, a communications device, a telephone, a personal digital assistant (PDA), an iPhone, a 3G/4G wireless device, a wireless device, a personal computer (PC), a handheld PC, a laptop computer, a smart phone, a mobile device, a netbook, a handheld device, a portable device, an interactive television device (iTV), a digital video recorder (DVR), client workstations, thin clients, thick clients, fat clients, proxy servers, network communication servers, remote access devices, client computers, server computers, peer-to-peer devices, routers, web servers, data, media, audio, video, telephony or streaming technology servers, etc., may also be implemented using a computer such as that shown in FIG. 12. In an illustrative embodiment, services may be provided on demand using, e.g., an interactive television device (iTV), a video on demand system (VOD), via a digital video recorder (DVR), and/or other on demand viewing system. Computer system 1200 may be used to implement the network and components as described above. Such as the HMI, system controller 510, and/or the programmable logic controller. Computer system 1200 may be connected to antenna 260.

The computer system 1200 may include one or more processors, such as, e.g., but not limited to, processor(s) 1204. The processor(s) 1204 may be connected to a communication infrastructure 1206 (e.g., but not limited to, a communications bus, cross-over bar, interconnect, or network, etc.). Processor 1204 may include any type of processor, microprocessor, or processing logic that may interpret and execute instructions (e.g., for example, a field programmable gate array (FPGA)). Processor 1204 may comprise a single device (e.g., for example, a single core) and/or a group of devices (e.g., multi-core). The processor 1204 may include logic configured to execute computer-executable instructions configured to implement one or more embodiments. The instructions may reside in main memory 1208 or secondary memory 1210. Processors 1204 may also include multiple independent cores, such as a dual-core processor or a multi-core processor. Processors 1204 may also include one or more graphics processing units (GPU) which may be in the form of a dedicated graphics card, an integrated graphics solution, and/or a hybrid graphics solution. Various illustrative software embodiments may be described in terms of this illustrative computer system. After reading this description, it will become apparent to a person skilled in the relevant art(s) how to implement the invention and/or parts of the invention using other computer systems and/or architectures.

Computer system 1200 may include a display interface 1202 (e.g., the HMI) that may forward, e.g., but not limited to, graphics, text, and other data, etc., from the communication infrastructure 1206 (or from a frame buffer, etc., not shown) for display on the display unit 1201. The display unit 1201 may be, for example, a television, a computer monitor, a touch sensitive display device, or a mobile phone screen. The output may also be provided as sound through a speaker.

The computer system 1200 may also include, e.g., but is not limited to, a main memory 1208, random access memory (RAM), and a secondary memory 1210, etc. Main memory 1208, random access memory (RAM), and a secondary memory 1210, etc., may be a computer-readable medium that may be configured to store instructions configured to implement one or more embodiments and may comprise a random-access memory (RAM) that may include RAM devices, such as Dynamic RAM (DRAM) devices, flash memory devices, Static RAM (SRAM) devices, etc.

The secondary memory 1210 may include, for example, (but is not limited to) a hard disk drive 1212 and/or a removable storage drive 1214, representing a floppy diskette drive, a magnetic tape drive, an optical disk drive, a compact disk drive CD-ROM, flash memory, etc. The removable storage drive 1214 may, e.g., but is not limited to, read from and/or write to a removable storage unit 1218 in a well-known manner. Removable storage unit 1218, also called a program storage device or a computer program product, may represent, e.g., but is not limited to, a floppy disk, magnetic tape, optical disk, compact disk, etc. which may be read from and written to removable storage drive 1214. As will be appreciated, the removable storage unit 1218 may include a computer usable storage medium having stored therein computer software and/or data.

In alternative illustrative embodiments, secondary memory 1210 may include other similar devices for allowing computer programs or other instructions to be loaded into computer system 1200. Such devices may include, for example, a removable storage unit 1222 and an interface 1220. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 1222 and interfaces 1220, which may allow software and data to be transferred from the removable storage unit 1222 to computer system 1200.

Computer 1200 may also include an input device 1203 which may include any mechanism or combination of mechanisms that may permit information to be input into computer system 1200 from, e.g., a user or operator. Input device 1203 may include logic configured to receive information for computer system 1200 from, e.g. a user or operator. Examples of input device 1203 may include, e.g., but not limited to, a mouse, pen-based pointing device, or other pointing device such as a digitizer, a touch sensitive display device, and/or a keyboard or other data entry device (none of which are labeled). Other input devices 1203 may include, e.g., but not limited to, a biometric input device, a video source, an audio source, a microphone, a web cam, a video camera, and/or other camera.

Computer 1200 may also include output devices 1215 which may include any mechanism or combination of mechanisms that may output information from computer system 1200. Output device 1215 may include logic configured to output information from computer system 1200. Embodiments of output device 1215 may include, e.g., but not limited to, display 1201, and display interface 1202, including displays, printers, speakers, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), etc. Computer 1200 may include input/output (I/O) devices such as, e.g., (but not limited to) input device 1203, communications interface 1224, connection 1228 and communications path 1226, etc. These devices may include, e.g., but are not limited to, a network interface card, onboard network interface components, and/or modems.

Communications interface 1224 may allow software and data to be transferred between computer system 1200 and external devices or other computer systems. Computer system 1200 may connect to other devices or computer systems via wired or wireless connections. Wireless connections may include, for example, WiFi, satellite, mobile connections using, for example, TCP/IP, 802.15.4, high rate WPAN, low rate WPAN, 6loWPAN, ISA100.11a, 802.11.1, WiFi, 3G, WiMAX, 4G and/or other communication protocols. Wireless communication may be provided through antenna 260.

In this document, the terms “computer program medium” and “computer readable medium” may be used to generally refer to media such as, e.g., but not limited to, removable storage drive 1214, a hard disk installed in hard disk drive 1212, flash memories, removable discs, non-removable discs, etc. In addition, it should be noted that various electromagnetic radiation, such as wireless communication, electrical communication carried over an electrically conductive wire (e.g., but not limited to twisted pair, CAT5, etc.) or an optical medium (e.g., but not limited to, optical fiber) and the like may be encoded to carry computer-executable instructions and/or computer data that embodiments of the invention on e.g., a communication network. These computer program products may provide software to computer system 1200. It should be noted that a computer-readable medium that comprises computer-executable instructions for execution in a processor may be configured to store various embodiments of the present invention. References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic.

Further, repeated use of the phrase “in one embodiment,” or “in an illustrative embodiment,” do not necessarily refer to the same embodiment, although they may. The various embodiments described herein may be combined and/or features of the embodiments may be combined to form new embodiments.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

Embodiments may be embodied in many different ways as a software component. For example, it may be a stand-alone software package, or it may be a software package incorporated as a “tool” in a larger software product, such as, for example, a scientific modeling product. It may be downloadable from a network, for example, a website, as a stand-alone product or as an add-in package for installation in an existing software application. It may also be available as a client-server software application, or as a web-enabled software application. It may also be part of a system for detecting network coverage and responsiveness. Computer system 1200 may be used to create a general purpose computer. A general purpose computer may be specialized by storing programming logic that enables one or more processors to perform the techniques indicated herein and one or more of the steps of FIG. 11. Computer system 1200 or multiple embodiments of computer system 1200 may be used to perform the functions of the control system described above.

Embodiments of the present invention may include apparatuses for performing the operations herein. An apparatus may be specially constructed for the desired purposes, or it may comprise a general purpose device selectively activated or reconfigured by a program stored in the device.

Embodiments may be embodied in many different ways as a software component. For example, it may be a stand-alone software package, or it may be a software package incorporated as a “tool” in a larger software product. It may be downloadable from a network, for example, a website, as a stand-alone product or as an add-in package for installation in an existing software application. It may also be available as a client-server software application, or as a web-enabled software application.

FIGS. 13-16 depict example screen shots from HMI to control system 510 via, for example, a touch screen interface. FIGS. 13-16 may also be remotely accessible. FIG. 13 depicts initial control panel screen 1300 in an illustrative embodiment. Initial control panel screen 1300 may contain an on/off switch, emergency stop, real time power analytics, and access to other screens such as the engine, power control sub system (PCSS), battery, and alarm screens.

FIG. 14 depicts an example power control sub system (PCSS) control panel screen 1400 in an illustrative embodiment. PCSS screen 1400 may display, for example, voltage between each phase & neutral, voltage between phases, current (amps) on each phase, frequency, active, apparent and reactive power, power factor, instant power (kWH) and accumulative power, fuel reserve, oil pressure, coolant temperature, battery voltage, battery charging alternator voltage, engine speed, hours running (total & partial). Note, all the protections are programmable to carry out warning alarm without engine stop or an alarm with engine stop (with or without cooling cycle).

FIG. 15 depicts an example engine data control panel screen 1500 in an illustrative embodiment. Engine data screen 1500 may display, for example, high coolant temperature, low oil pressure, low coolant level, unexpected shutdown, low fuel level, stop failure, battery voltage failure, battery charging alternator failure, over-speed, under-speed, and start failure.

FIG. 16 depicts an example alarm control panel screen 1600 in an illustrative embodiment. Alarm screen 1600 may display various alarms, alerts, and/or faults processed by controller 510. Alarm may also include an audible tone. The alarms may include, for example, over-load, unbalanced voltage, over voltage, under voltage, over frequency, under frequency, short-circuit, reverse power, and incorrect phase sequence.

While various embodiments of the present invention have been described above, it should be understood that they have been presented by way of example only, and not limitation. Thus, the breadth and scope of the present invention should not be limited by any of the above-described illustrative embodiments, but should instead be defined only in accordance with the following claims and their equivalents. The embodiments of the present invention that have been described above may contain features that may be removed or combined between the described embodiments to derive additional embodiments.

What is claimed is:

1. A hybrid generator comprising:
a fuel powered engine;
an alternator comprising a permanent magnet alternator head with at least 90% mechanical-to-electric efficiency, the alternator being coupled to the engine;
one or more batteries to receive and store power routed from the alternator;
a controller to maintain efficient operating speed of the engine at prime power; and
a power converter or inverter to convert stored energy from the batteries into usable electricity for AC or DC loads.

2. The generator of claim 1, further comprising:
a waste heat recapture system.

3. The generator of claim 2, wherein the waste heat recapture system comprises:
an engine water jacket providing cooling for the engine; and
a water jacket heat exchanger coupled to the engine water jacket, wherein the waste heat recapture system converts heat into mechanical power to be converted to electricity.

4. The generator of claim 2, wherein the waste heat recapture system comprises:
an exhaust gas heat exchange system to extract heat from exhaust gas emitted from the engine, wherein the extracted heat energizes a working fluid from which mechanical energy can be extracted and converted to electricity.

5. The generator of claim 4, further comprising:
a water filter for filtering collected condensation from the exhaust gas.

6. The generator of claim 1, further comprising:
a turbocharger.

7. The generator of claim 1, wherein the engine is a diesel engine.

8. The generator of claim 1, wherein the hybrid generator is mounted on a portable trailer.

9. The generator of claim 1, further comprising:
an electrical fan;
sound deadening thermal insulation;
an inverter capable of outputting a higher peak power than that of the alternator;
one or more wind turbines;
one or more solar panels; and
an antenna for wireless connectivity.

10. A power generating grid comprising:
a plurality of the hybrid generators of claim 1 connected together, wherein one or more of the hybrid generators of the plurality of hybrid generators are switched on or off to meet energy demand.

11. A method of operating a hybrid generator comprising:
initiating startup by a system controller;
measuring battery power level by the system controller;
energizing one or more glow plugs;
energizing an engine starter for an engine, the engine coupled to an alternator;
starting the engine;
cooling the engine using a water jacket;
determining, by the system controller, if the engine started;
measuring, by the system controller, a temperature of a liquid in the water jacket;
instructing, by the system controller, the generator to produce energy at a selected percentage of the alternator maximum capacity based on the measured water jacket temperature;
instructing, by the system controller, the engine to operate at the most efficient power setting regardless of a requested energy demand; storing excess output in batteries; and
initiating a shutdown of the engine when the measured battery power level reaches a designated level.

12. The method of claim 11, wherein the most efficient power setting comprises operating at 100% prime power.

13. The method of claim 11, further comprising:
measuring, by the system controller, the engine operating speed;
initiating shutdown the engine if the operating speed does not exceed a given threshold; and
outputting an engine shutdown alert;

14. The method of claim 11, further comprising:
extracting heat from the liquid in the water jacket using a heat exchanger;
converting the extracted heat into mechanical and then into electrical energy; and
storing the energy in onboard batteries.

15. The method of claim 14, wherein the heat exchanger is a parallel plate heat exchanger.

16. The method of claim 11, further comprising:
funneling exhaust gasses from the engine through a heat exchanger;
extracting heat from the exhaust gasses;
converting the extracted heat into mechanical and then into electrical energy; and
storing the energy in onboard batteries.

17. The method of claim 16, wherein the heat exchanger is a fin heat exchanger.

18. The method of claim 11, wherein the startup is initiated based on a user request or a low battery measurement.

19. The method of claim 11, further comprising:
forming a power grid by connecting a plurality of hybrid generators, wherein the power grid can supply 2 kW to 2 MW of power;
meeting a power demand by switching one or more hybrid generators of the plurality of hybrid generators on or off; and
remotely controlling the power grid.

20. The method of claim 11, further comprising:
wirelessly accessing the system controller to view maintenance requirements or to view or edit system settings.

21. The method of claim 11, further comprising:
collecting water condensation from an exhaust gas heat exchanger;
filtering the collected water condensation; and
providing potable water.
